(19) United States
(12) Patent Application Publication
(10) Pub. No.: US 2006/0203104 A1
(43) Pub. Date: Sep. 14, 2006

(54) Method for checking the processing of digital photo transmission messages

(76) Inventors: Jean-Marie Vau, Chalon-sur-Saone (FR); Nicolas Touchard, Suresnes (FR); Santie Adelbert, Vincennes (FR)

Correspondence Address: PATENT LEGAL STAFF, EASTMAN KODAK COMPANY, 343 STATE STREET, ROCHESTER, NY, 14650-2201, US

(21) Appl. No.: 10/549,794

(22) PCT Filed: Mar. 5, 2004
(86) PCT No.: PCT/EP04/02277

§ 371 Date: Mar. 21, 2006

(30) Foreign Application Priority Data
Mar. 20, 2003 (FR) 0303388

(51) Int. Cl. H04N 5/76

(52) U.S. Cl. 348/231.3; 709/217

(57) ABSTRACT

Method for checking the processing of digital photo image data from mobile telephone equipment intended for an image management service provider, comprising,—the establishment of geographic localization data (13), (13a) of the mobile imaging equipment, and—the execution of processing checking instructions (20, 50, 54, 56), according to the mobile imaging equipment localization data, so as to prevent at least one image processing step when the localization data corresponds to a place where image capture is prohibited. Application to mobile phones provided with image sensor or digital cameras having a wireless link.

### TECHNICAL FIELD

The present invention relates to a method for checking the processing of digital photo transmission messages. The invention has applications in the field called mobile imaging. The term “mobile imaging”, by analogy with the mobile phone, designates shooting systems combining a digital camera and a communication means for transferring the captured images or image sequences. More precisely, the communication means enable image data to be sent to an image management service provider. Image transmission is, at least in part, by telephone or radio type transmission. It thus enables great mobility of the shooting systems. Among these systems one may cite, for illustration purposes, mobile phones integrating a camera or sensor for letting the user capture images.

Mobile telephone equipment is provided with memory for temporarily storing the captured images. This memory is usually of modest size. However, images can be transmitted to an image management service provider, which ensures the conservation of the images as electronic albums that can be browsed remotely. The service provider can also organize the distribution or sharing of the images and ensure the printing of photographic proofs from the transmitted digital data.

The multiplication of mobile imaging equipment is modifying the behavior of users and raises extra problems related to image rights. The use of conventional cameras, relatively bulky and easily detectable, can easily be prevented. It is not the same for mobile imaging equipment. Mobile equipment, and in particular mobile phones provided with a camera, can easily be concealed. They can also be introduced into places where access to the image is subject to restrictions. Among these places, one may cite auditoriums, art exhibition rooms or premises for storing documents or instruments whose reproduction as an image would be a violation of rights.

The unauthorized use of mobile imaging equipment is all the more difficult to control as the cameras involved are usually silent and small.

While the unauthorized use of mobile imaging equipment can be use in good faith, it may also be fraudulent. In this case image management service providers may legitimately not wish to participate in the processing of “stolen” images.

### DESCRIPTION OF THE INVENTION

The purpose of the invention is to propose a method for checking the processing of digital photos captured by mobile imaging equipment, so as to prevent the capture or at least the propagation of unauthorized digital photos.

The checking method can be implemented for the profit of the image management service provider, and for the service of the user, so as to guarantee to them that the images they capture do not come from a place where photography is prohibited.

To achieve these objects, the invention relates more precisely to a method for checking the processing of image data from mobile phone equipment, and directed to an image management service provider; the method comprises:
the establishment of geographic localization data of the mobile imaging equipment, and
the execution of processing checking instructions, according to the localization data, so as to prevent at least one image processing step when the localization data corresponds to a place where image capture is prohibited.

The prohibition to execute at least one step can be a temporary or permanent prohibition.

In particular the method can be implemented to perform a filtering of an image content captured by the user.

As indicated in the introductory part, mobile telephone equipment means any device or system of devices, combining digital shooting means and radio transmission means for image data.

The processing of one or more digital images of mobile imaging equipment can comprise many steps. The processing comprises, for example, the capture of an image by triggering a shooting device, the conversion of an acquisition signal into a data image, the temporary storage of these data, data transmission towards an image management service provider, data storage by the service provider, and possibly the distribution of the images by the service provider.

The prohibition of a processing step can take place on the service provider side, or on the user side. For example, the checking instructions mentioned above can contain the rejection of images transmitted by mobile equipment. This rejection is performed by a server of the service provider. The server can also be programmed not to record the image, to prohibit its transmission or not ensure any distribution of it.

The prohibition of processing can also be implemented by the issue of a message, including one or more executable program instructions, from the service provider to the user. Such a message can be used to authorize or prohibit the execution of a program part, designed for this purpose, and existing in the mobile imaging equipment. To prevent the processing of an image from a place where shooting is prohibited, the message can contain, for example, a program instruction which prohibits the data transmission from the user, which prohibits local data storage, or which more simply prohibits the triggering of the shot. The program instruction can also cause an invisible marking (watermarking) of the images by associating metadata with them. These data can, in turn, be used to condition other subsequent processing steps, affecting the image data The geographic localization data can be data indicating the place of image capture, or the place from which a telecommunications link is established with the image management service providers, or again the place from which image data are transmitted. The localization data may come from a global positioning system (GPS) built into the mobile imaging equipment. It can also be established by the telecommunications operator providing the message transmission between the user of the mobile imaging equipment and the image management services provider. In this case, the data is obtained by triangulation between the telephone relay stations.

Temporal data of the shot or transmission of the messages can be added to the localization data. This data enables the processing of situations where the shooting prohibition, in force in a given place, only lasts for a limited period. It is taken into account for the execution of the checking instruction, for example, by delaying a shot or the transmission of image data.

Other characteristics and advantages of the invention will appear in the following description, with reference to the FIGURE of the appended drawing. This description is given purely as an illustration and is not limiting.

### BRIEF DESCRIPTION OF THE FIGURE

FIG. 1, single, is a diagram giving the implementation steps of a checking method according to the invention, and a number of possible alternatives for this method.

### DETAILED DESCRIPTION OF THE MODES OF IMPLEMENTING THE INVENTION

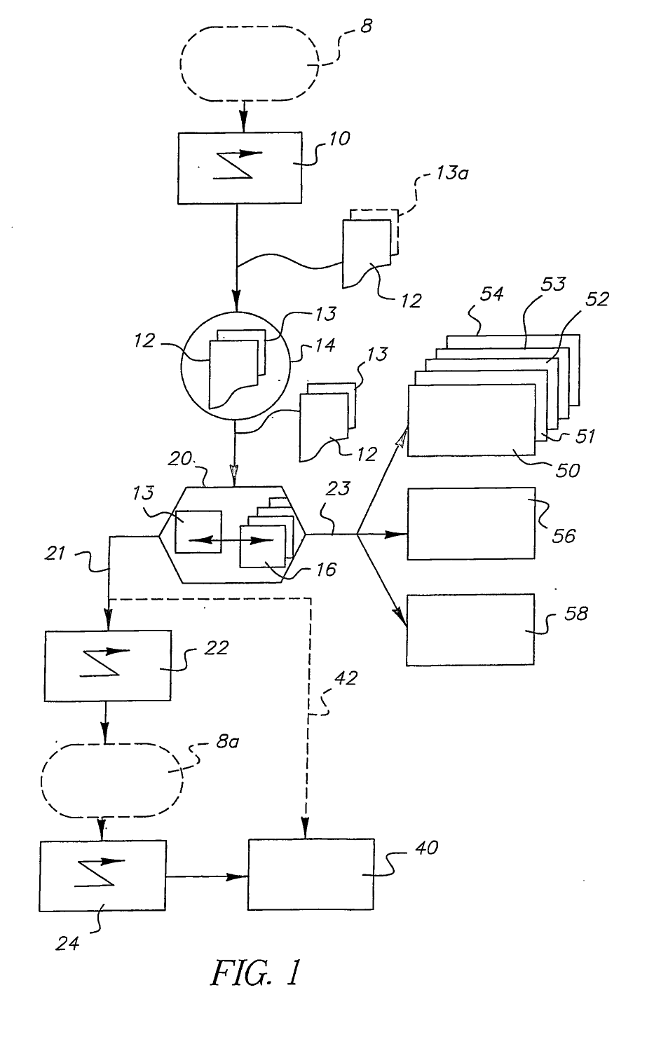

Item 10 of FIG. 1 shows a first transmission of a message 12 by the mobile imaging equipment of a user in the direction of an image management service provider. The message can be transmitted following an explicit command effected by the user or can be transmitted automatically in response to triggering a shot.

In the illustrated example, the message 12 is a simple message requesting data transmission or more generally requesting processing. However, according to an alternative, the message may also contain image data intended for the image management service provider. In this sense, item 8 shows the previous shooting and formatting operations of the image data attached to the message 12. The possible step corresponding to item 8 is shown with a dotted line to show that it is a simple alternative of implementing the method.

Item 14 shows a telecommunications operator and a transmission step of the message 12 by means of this operator. During the step 14, one or more data components 13 are added to the message. This is localization data or temporal data giving the place and possibly the time and date of the message transmission. These data can be established by the telecommunications operator. The localization data results from a triangulation calculation from several relay stations receiving the message 12 and the temporal data can be supplied by a simple electronic clock.

The localization data and temporal data can also be added to the message as soon as it is transmitted by the mobile imaging equipment. This is possible if the imaging equipment is provided with a positioning system and/or a clock. In this case, the localization data, shown in dotted line with item 13a, can inform the image management service provider not only on the place and time of sending the message but also on the place and time of the shot. The data 13a from the mobile imaging equipment can also identify the user. It can also be combined or not with the data 13 established by the telecommunications operator.

The item 20 shows a checking step performed by a server of the image management service provider. The check consists in comparing the data 13 or 13a, with a previously recorded list or database 16. The previously recorded data lists the places where photography is prohibited, the times when the recording of photographs is prohibited in these places, and data indicating image rights payments and/or the terms and conditions of shooting authorization.

When the data 13a transmitted with the message 12 are sufficient to identify the user, the check 20 can also include a verification for establishing if the transmitting user has or not settled the image rights for the captured images at the place corresponding to the localization data.

If the check finds no reason for prohibiting processing, the processing can be continued favorably. The continuation of the processing is shown by an arrow 21.

The processing is continued, for example by the sending 22 of a message from the image processing service provider to the user's mobile imaging equipment. The message contains an instruction authorizing the shot, or an instruction for sending the image data.

In response to this message one or more shots can be taken by the mobile imaging equipment and converted into image data These operations are shown by item 8a.

The image data are then sent to the image management service provider, or more precisely to a server (computer) of this service provider, in step 24.

In the particular cases where the shots were already previously taken during step 8, i.e. before the sending of the message 10, the method can be directly continued by the sending of the image data from the internal memory of the mobile imaging equipment to the service provider's server. The shooting step 8a can then be omitted.

The block 40 shows generally the reception of the image data by the server of the image management service provider, the storing of the data, the creation of an electronic album that can be browsed remotely, the distribution of the images, the printing of proofs from the image data or any other service capable of being supplied by the service provider from the image data received.

According to an alternative, in which the image data had already been transmitted during the sending of the message 10, i.e. before the authorization check, and the authorization check not finding any prohibition, the image data can be processed directly in the way mentioned above. This alternative is shown by an arrow 42 with dotted lines linked directly to the block 40.

If the checking step 20 finds that the localization data 13 or 13a correspond to a place where shooting is prohibited or restricted, temporarily or permanently, the continuation of the processing of block 40 is prohibited or at least subject to additional conditions. This situation corresponds, in the figure, to an arrow 23 and can have various outcomes. The method can be completed by the sending of various types of program instruction. This is, for example, an instruction 50 prohibiting the triggering of the shot, an instruction 51 prohibiting the local storage of image data, an instruction 52 prohibiting the transmission of image data, or again an instruction 53 forcing the display on the control screen of the mobile imaging equipment of information alerting the user that they may not photograph. The instruction consisting in prohibiting the transmission of image data can be an absolute prohibition or a prohibition limited to a given geographic zone and/or time period.

The method can also be continued by the sending or the execution of an instruction authorizing the shot, the transmission of the data and their full or partial processing, but requiring marking of the image. This possibility is shown by item 54. The marking can be a visible marking or an invisible marking (watermarking) consisting in adding identification data to the image data, for recognizing the existence of restricted image rights.

According to an alternative, shown by item 56, the method can be continued by the execution of steps letting the user acquire the rights to the captured images. If these rights are settled, the continuation of the block 40 processing can take place.

Finally, the program can be stopped by the simple rejection 58 of the transmitted images by not performing any processing step.

It may be noted that the creation of the database 16 used for the operations of content filtering, or payment of rights can be entrusted to agencies managing artistic or sporting rights (SACEM, Sports Federations, etc.). Other private entities (Bar, Club, etc.) can also fully prohibit shooting on their premises for privacy rights compliance reasons.

1) A method for checking the processing of digital photo image data from mobile telephone equipment intended for an image management service provider, comprising,
the establishment of geographic localization data (13), (13a) of the mobile imaging equipment, and
the execution of processing checking instructions (20, 50, 54, 56), according to the mobile imaging equipment localization data, so as to prevent at least one image processing step when the localization data corresponds to a place where image capture is prohibited.

2) A method according to claim 1, wherein the checking instruction includes the rejection (58) of images transmitted from the mobile imaging equipment.

3) A method according to claim 1, wherein the processing checking instruction includes the sending of a message containing an executable instruction (50, 51, 52, 53, 54) to the mobile imaging equipment.

4) A method according to claim 3, wherein the executable instruction is an instruction (52) prohibiting image data transmission to the service provider.

5) A method according to claim 3, wherein the executable instruction is an instruction (54) for marking the transmitted images.

6) A method according to claim 3, wherein the executable instruction is an instruction (50) prohibiting the triggering of the shot.

7) A method according to claim 1, wherein the geographic localization data (13) is established by a telecommunications operator providing the message transmission between the mobile imaging equipment and the image management service provider.

8) A method according to claim 1 comprising in addition, the establishment of temporal data of the shot or of the transmission of a processing request message intended for the image management service provider, and the taking into account of the temporal data for the execution of the checking instruction.
